(19) United States
(12) Patent Application Publication
(10) Pub. No.: US 2026/0332537 A1
(43) Pub. Date: Oct. 22, 2026

(54) DYNAMIC DATA FIDELITY LEVEL ADJUSTMENT SYSTEM AND METHOD FOR IMPROVED DATA TRANSFER

(71) Applicant: CABLE TELEVISION LABORATORIES, INC., Louisville, CO (US)

(72) Inventors: John C. Bahr, Superior, CO (US); Stephen Arendt, Longmont, CO (US)

(21) Appl. No.: 19/651,280

(22) Filed: Apr. 17, 2026

Related U.S. Application Data
(60) Provisional application No. 63/790,691, filed on Apr. 17, 2025.

(51) Int. Cl. H04L 47/76; H04L 47/72

(52) U.S. Cl. CPC H04L 47/76; H04L 47/72

(57) ABSTRACT

Dynamic data fidelity level adjustment systems and methods are provided. A first endpoint device (FED) comprises a FED data processing agent configured to transmit one or more data packets at a data fidelity level and a FED flow control agent configured to (i) receive one or more second endpoint device (SED) messages, (ii) determine whether to accept or deny a requested data fidelity level when the one or more SED messages are received, or (iii) transmit one or more FED messages having a success response or a failure response. The SED comprises: a SED data processing agent configured to receive one or more data packets at a data fidelity level and a SED flow control agent configured to transmit the one or more SED messages having at least a SED change request with the requested data fidelity level.

### CROSS REFERENCE TO RELATED APPLICATIONS

This application claims the benefit of and priority to U.S. Provisional Application No. 63/790,691, filed on Apr. 17, 2025, which is incorporated herein by reference in its entirety.

### BACKGROUND

The field of the disclosure relates generally to adjusting data fidelity levels, and more particularly, to dynamic data fidelity level adjustment systems and methods for improved data transfer.

Modern data‑processing systems often rely on the transfer of large volumes of data between distributed endpoint devices. Such data may include video streams, sensor data, analytical datasets, or other information that is transferred from one endpoint device and processed at another endpoint device. In many scenarios, this data must be transmitted within a timeframe appropriate for an endpoint receiving device’s processing needs. For example, machine learning models receive large amounts of data for processing and/or training from other devices. In another example, autonomous vehicles rely on transmitting geolocation data to a server device for processing. However, available network bandwidth, latency, jitter, and computational capacity may vary substantially over time. As a result, the data in these examples, or any application, may not always be delivered at its original resolution or in the required timeframe for sufficient processing.

Existing adaptive‑streaming technologies can adjust a resolution of video streams to accommodate changing network conditions, but these solutions are narrowly tailored to traditional media and are typically limited to fixed adjustments. There is no comparable, generalized framework for dynamically adjusting the parameters of arbitrary data to match real‑time constraints. The problem is further compounded in architectures that involve bidirectional data exchange, such as client–server systems that exchange both uplink and downlink data. Each direction of communication may face distinct bandwidth limitations or processing constraints, and the appropriate data resolution for one direction may not match the needs or constraints of the other.

Accordingly, there is a need for improved techniques that allow communicating devices to dynamically negotiate and adjust parameters of transmitted data in any direction and can support diverse data types beyond traditional video streams.

### SUMMARY

Dynamic data fidelity level adjustment systems and methods for improved data transfer are provided. The systems and methods enable adjustments and negotiations of data fidelity levels when a data fidelity trigger such as, for example, reduced network conditions is detected by an endpoint device. One or more properties of the data fidelity levels can be adjusted or negotiated automatically to accommodate the detected data fidelity trigger while maintaining priority data fidelity properties to ensure timely data transfer.

A dynamic data fidelity level adjustment system according to at least one embodiment of the present disclosure comprises a first endpoint device (FED) comprising: a FED data processing agent configured to transmit one or more data packets at a data fidelity level; and a FED flow control agent configured to at least one of (i) receive one or more second endpoint device (SED) messages, (ii) determine whether to accept or deny a requested data fidelity level when the one or more SED messages are received, and (iii) transmit one or more FED messages having a success response or a failure response; and the SED comprising: a SED data processing agent configured to receive one or more data packets at a data fidelity level; and a SED flow control agent configured to transmit the one or more SED messages having at least a SED change request with the requested data fidelity level, wherein the SED transmits the one or more SED messages to the FED when a data fidelity level trigger occurs and the FED determines whether to accept or deny the requested data fidelity level, and wherein the FED transmits the one or more data packets at a new data fidelity level when the data fidelity level trigger occurs.

Any of the aspects herein, wherein the FED flow control agent transmits the one or more FED messages when the FED determines whether to accept or deny the requested data fidelity level.

Any of the aspects herein, wherein the one or more FED messages includes at least one of a success response when the FED determines to accept the requested data fidelity level or a failure response when the FED determines to deny the requested data fidelity level.

Any of the aspects herein, wherein the FED flow control agent determines whether to accept or deny the requested data fidelity level based on at least one of processing power, device power, device capabilities, or network conditions.

Any of the aspects herein, wherein the requested data fidelity level is based on the data fidelity level trigger.

Any of the aspects herein, wherein the dynamic data fidelity level adjustment system is a one-way data flow system.

Any of the aspects herein, wherein the SED data processing agent is further configured to transmit an acknowledgement packet when the FED transmits the one or more FED messages having the success response or the failure response.

Any of the aspects herein, wherein each data packet of the one or more data packets includes a header and a data payload.

Any of the aspects herein, wherein the header includes data fidelity level information corresponding to the data fidelity level at which the data packet was transferred.

A dynamic data fidelity level adjustment system according to at least one embodiment of the present disclosure comprises a first endpoint device (FED) comprising: a FED data processing agent configured to transmit one or more upstream data packets at an upstream data fidelity level and to receive one or more downstream data packets at a downstream data fidelity level; and a FED flow control agent configured to at least one of (i) transmit one or more FED messages having at least a FED change request and a requested downstream data fidelity level, (ii) receive one or more second endpoint device (SED) messages having at least a SED change request and a requested upstream data fidelity level, (iii) determine whether to accept or deny the requested upstream data fidelity level when the one or more SED messages are received, and (iv) transmit one or more FED messages having a success response or a failure response, the SED comprising: a SED data processing agent configured to transmit the one or more downstream data packets at the downstream data fidelity level and to the receive one or more upstream data packets at the upstream data fidelity level; and a SED flow control agent configured to at least one of (i) transmit the one or more SED messages having at least the SED change request and the requested upstream data fidelity level, (ii) receive the one or more FED messages having at least the FED change request and the requested downstream data fidelity level, (iii) determine whether to accept or deny the requested downstream data fidelity level when the one or more FED messages are received, and (iv) transmit one or more SED messages having the success response or the failure response, wherein the SED transmits the one or more SED messages to the FED when an upstream data fidelity level trigger occurs and the FED determines whether to accept or deny the requested new upstream data fidelity level, wherein the FED transmits the one or more upstream data packets at a new upstream data fidelity level when the upstream data fidelity level trigger occurs, wherein the FED transmits the one or more FED messages to the SED when a downstream data fidelity level trigger occurs and the SED determines whether to accept or deny the requested new downstream data fidelity level, and wherein the SED transmits the one or more downstream data packets at a new downstream data fidelity level when the downstream data fidelity level trigger occurs.

Any of the aspects herein, wherein the FED flow control agent transmits the one or more FED messages when the FED determines whether to accept or deny the requested upstream data fidelity level.

Any of the aspects herein, wherein the one or more FED messages includes at least one of a success response when the FED determines to accept the requested upstream data fidelity level or a failure response when the FED determines to deny the requested upstream data fidelity level.

Any of the aspects herein, wherein the FED flow control agent determines whether to accept or deny the requested upstream data fidelity level based on at least one of processing power, device power, device capabilities or network conditions .

Any of the aspects herein, wherein the SED flow control agent transmits the one or more SED messages when the SED determines whether to accept or deny the requested downstream data fidelity level.

Any of the aspects herein, wherein the one or more SED messages includes at least one of a success response when the SED determines to accept the requested downstream data fidelity level or a failure response when the SED determines to deny the requested downstream data fidelity level.

Any of the aspects herein, wherein the SED flow control agent determines whether to accept or deny the requested downstream data fidelity level based on at least one of processing power, device power, device capabilities, or network conditions.

Any of the aspects herein, wherein the requested upstream data fidelity level is based on the upstream data fidelity level trigger and the requested downstream data fidelity level is based on the downstream data fidelity level trigger.

Any of the aspects herein, wherein the dynamic data fidelity level adjustment system is a two-way data flow system.

Any of the aspects herein, wherein the SED data processing agent is further configured to transmit an acknowledgement packet when the FED transmits the one or more FED messages having the success response or the failure response.

Any of the aspects herein, wherein the FED data processing agent is further configured to transmit an acknowledgement packet when the SED transmits the one or more SED messages having the success response or the failure response.

A method of dynamically adjusting a data fidelity level according to at least one embodiment of the present disclosure comprises transmitting, by a first endpoint device (FED), one or more data packets to a second endpoint device (SED) at a data fidelity level; detecting, by the FED, a data fidelity level trigger; and transmitting, by the FED and in response to detecting the data fidelity level trigger, the one or more data packets at a new data fidelity level.

A method of dynamically adjusting a data fidelity level according to at least one embodiment of the present disclosure comprises receiving, by a second endpoint device (SED), one or more data packets from a first endpoint device (FED) at a data fidelity level; detecting, by the SED, a data fidelity level trigger; transmitting, by the SED, a SED message to the FED, the SED message including change request and a requested data fidelity level; determining, by the FED, whether to accept or deny the requested data fidelity level; and transmitting, by the FED, a FED message indicating acceptance or denial of the requested data fidelity level.

A method of dynamically adjusting an upstream data fidelity level according to at least one embodiment of the present disclosure comprises transmitting, by a first endpoint device (FED), one or more upstream data packets to a second endpoint device (SED) at an upstream data fidelity level; detecting, by the FED, an upstream data fidelity level trigger; and transmitting, by the FED and in response to detecting the upstream data fidelity level trigger, the one or more upstream data packets at a new upstream data fidelity level.

A method of dynamically adjusting a downstream data fidelity level according to at least one embodiment of the present disclosure comprises transmitting, by a second endpoint device (SED), one or more downstream data packets to a first endpoint device (FED) at a downstream data fidelity level; detecting, by the SED, a downstream data fidelity level trigger; and transmitting, by the SED and in response to detecting the downstream data fidelity level trigger, the one or more downstream data packets at a new downstream data fidelity level.

A method of dynamically adjusting a downstream data fidelity level according to at least one embodiment of the present disclosure comprises receiving, by a first endpoint device (FED), one or more downstream data packets from a second endpoint device (SED) at a downstream data fidelity level; detecting, by the FED, a downstream data fidelity level trigger; transmitting, by the FED, a FED message comprising a change request message to the SED, the change request message including a requested downstream data fidelity level; determining, by the SED, whether to accept or deny the requested downstream data fidelity level; and transmitting, by the SED, a SED message indicating acceptance or denial of the requested downstream data fidelity level.

The details of one or more aspects of the disclosure are set forth in the accompanying drawings and the description below. Other features, objects, and advantages of the techniques described in this disclosure will be apparent from the description and drawings, and from the claims.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present invention will become apparent to those skilled in the art upon consideration of the embodiment descriptions provided hereinbelow.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1A is a block diagram of a dynamic data fidelity level adjustment system, according to at least one embodiment of the present disclosure;

FIG. 1B is a block diagram of a message for use in the dynamic data fidelity level adjustment system of FIG. 1A, according to at least one embodiment of the present disclosure;

FIG. 1C is a block diagram of a data packet for use in the dynamic data fidelity level adjustment system of FIG. 1A, according to at least one embodiment of the present disclosure;

FIG. 1D is a block diagram of an acknowledgement packet for use in the dynamic data fidelity level adjustment system of FIG. 1A, according to at least one embodiment of the present disclosure;

FIG. 2A is message flow for a one-way data flow of a dynamic data fidelity level adjustment system, according to at least one embodiment of the present disclosure;

FIG. 2B is another message flow for a one-way data flow of a dynamic data fidelity level adjustment system, according to at least one embodiment of the present disclosure;

FIG. 2C is another message flow for a one-way data flow of a dynamic data fidelity level adjustment system, according to at least one embodiment of the present disclosure;

FIG. 3 is a logic flow for a one-way data flow of a dynamic data fidelity level adjustment system, according to at least one embodiment of the present disclosure;

FIG. 4A is a flowchart for a one-way data flow of a dynamic data fidelity level adjustment system, according to at least one embodiment of the present disclosure;

FIG. 4B is another flowchart for a one-way data flow of a dynamic data fidelity level adjustment system, according to at least one embodiment of the present disclosure;

FIG. 5A is message flow for a two-way data flow of a dynamic data fidelity level adjustment system, according to at least one embodiment of the present disclosure;

FIG. 5B is another message flow for a two-way data flow of a dynamic data fidelity level adjustment system, according to at least one embodiment of the present disclosure;

FIG. 5C is another message flow for a two-way data flow of a dynamic data fidelity level adjustment system, according to at least one embodiment of the present disclosure;

FIG. 6A is a first portion of a logic flow for a two-way data flow of a dynamic data fidelity level adjustment system, according to at least one embodiment of the present disclosure;

FIG. 6B is a second portion of the logic flow of FIG. 6A for a two-way data flow of a dynamic data fidelity level adjustment system, according to at least one embodiment of the present disclosure;

FIG. 7A is a flowchart for a two-way data flow of a dynamic data fidelity level adjustment system, according to at least one embodiment of the present disclosure;

FIG. 7B is another flowchart for a two-way data flow of a dynamic data fidelity level adjustment system, according to at least one embodiment of the present disclosure;

FIG. 7C is another flowchart for a two-way data flow of a dynamic data fidelity level adjustment system, according to at least one embodiment of the present disclosure; and

FIG. 7D is another flowchart for a two-way data flow of a dynamic data fidelity level adjustment system, according to at least one embodiment of the present disclosure.

### DETAILED DESCRIPTION

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (i.e., X₁ and X₂) as well as a combination of elements selected from two or more classes (i.e., Y₁ and Zₒ).

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

As used herein, the term “database” may refer to either a body of data, a relational database management system (RDBMS), or to both, and may include a collection of data including hierarchical databases, relational databases, flat file databases, object-relational databases, object-oriented databases, and/or another structured collection of records or data that is stored in a computer system.

As used herein, the terms “processor” and “computer” and related terms, i.e., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc – read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include computer program storage in memory for execution by personal computers, workstations, clients, and servers. More specifically, software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by computer processor(s), is configured to perform one or more embodiments, which may include transmitting, receiving, presenting, and displaying data and messages described in the other figures of the disclosure.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “telecommunication network” or “network” refers to a system of interconnected devices connected by links (e.g., cable, fiber, wireless, etc.) over which data can be transmitted between the interconnected devices. The telecommunication network can include, for example, cable networks, hybrid fiber-coaxial networks, fiber networks, a radio frequency network, any wired network, any wireless network, or any hybrid network.

The person of ordinary skill in the art will understand that the term “wireless,” as used herein in the context of transmission and communications generally refers to the absence of a substantially physical transport medium, such as wires or cables. Rather, wireless communication uses electromagnetic waves to transmit data through the air.

As used herein, the term “sender” generally refers to any device or module that is configured to generate, transmit, or otherwise output data, signals, messages, or information to another device or system such as a receiver. The sender may initiate transmissions autonomously or in response to a request.

As used herein, the term “receiver” generally refers to any device or module that is configured to receive, or otherwise interpret data, signals, messages, or information from a sender. The receiver may process the received data, store it, forward it, or perform operations based on the received data.

As used herein, the term “client” generally refers to any device or module that is configured to initiate a communication, request a service, transmit a command, or provide data to another device (such as a server) or system for processing. The client may include hardware, software, firmware, or any combination thereof and may communicate using any appropriate communication protocol, interface, or network.

As used herein, the term “server” generally refers any device or module that is configured to receive a communication, respond to a request, perform a service, process data, or provide information in response to a client. The server may include hardware, software, firmware, or any combination thereof and may support one or more clients concurrently or sequentially using any suitable communication protocol, interface, or network.

As used herein, an “agent” generally refers to a computer implemented software component that autonomously generates, selects, and executes one or more actions based on outputs, system state, and objective criteria, without requiring continuous human control. In some embodiments, the agent can interface or include a language model that autonomously generates, selects, and executes one or more actions. The agent may be configured to ingest inputs, consult with the language model, select and execute actions, and maintain state information. The agent may further be configured to evaluate outcomes and update itself in a feedback mechanism.

As used herein, “data fidelity level” refers to any parameter, characteristic, or measure indicating a degree of accuracy, completeness, detail, or representational quality of a data payload relative to its underlying source information. For example, a higher data fidelity level represents a data payload that preserves more of the data source’s original detail, precision, or informational richness, whereas a lower data fidelity level represents a data payload that conveys a reduced, simplified, compressed, or less detailed representation.

The data fidelity level may include one or more attributes such as, for example, data resolution, sampling rate, bit depth, precision, encoding parameters, compression settings, or other data‑quality characteristics. The term applies to any type of data, including multimedia streams, visual data, audio data, sensor signals, numerical or multidimensional arrays, time‑series data, etc.

As used herein, “data fidelity trigger” generally refers to a change in the network that necessitates a change in the data fidelity level such as increasing the data fidelity level or decreasing the data fidelity level. The change in the network can include, for example, a change in any of network conditions, endpoint processing capabilities, endpoint data needs, etc.

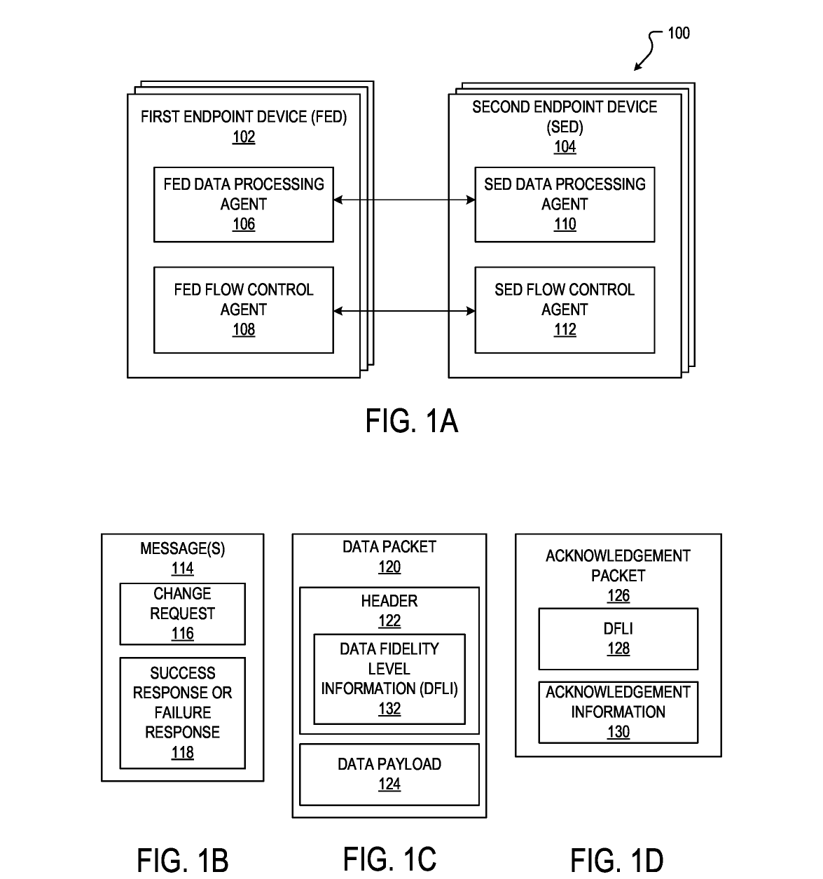

Turning to the Figures, FIG. 1A is a block diagram of a dynamic data fidelity level adjustment system (100) (also referred to as “the system (100)”), according to at least one embodiment of the present disclosure. The system (100) can be used in any network such as, for example, a telecommunications network. The system (100) enables dynamic data fidelity level adjustment between two or more endpoint devices to accommodate changes in network conditions or performance. For example, data fidelity levels can be adjusted to maintain a quality or a rate of transmission of data in one direction (e.g., one way data flow) or in two directions (e.g., bidirectional data flow) when increased network latency is detected. In the same example, the data fidelity levels can be adjusted back to the initial data fidelity levels or other levels when the network latency is no longer detected.

As shown, the system (100) includes a first endpoint device (FED) (102) and a second endpoint device (SED) (104). The FED (102) and the SED (104) are endpoint devices in communication with each other. In one example, the FED (102) may be a sender device, and the SED (104) may be a receiver device in a one-way data flow. In another example, the FED (102) may be a client device, and the SED (104) may be a server device in a two-way data flow. In any example, the FED (102) may include any number of FEDs such as one FED, two FEDs, or more than two FEDs, and the SED (104) may include any number of SEDs such as one SED, two SEDs, or more than two SEDs. Similarly, the FED (102) may be in communication with any number of SEDs (104), the SED (104) may be in communication with any number of FEDs (102), and any number of FED (102) may be in communication with any number of SED (104).

The FED (102) includes a FED data processing agent (106), and the SED (104) includes a corresponding SED data processing agent (110). Each of the FED data processing agent (106) and the SED data processing agent (110) are computer implemented software components that are configured to manage sending and receiving data packets such as data packets (120) (shown and described in FIG. 1C) and, optionally, sending and receiving acknowledgement packets such as acknowledgement packets (126) (shown and described in FIG. 1D).

In one-way data flows, the FED data processing agent (106) is configured to transmit data packets such as the data packets (120) at a data fidelity level, and the SED data processing agent (110) is configured to receive the data packets (120) at the data fidelity level. As previously defined, the data fidelity level can include, for example, data resolution, sampling rate, bit depth, encoding parameters, compression settings, etc.

In two-way data flows, the FED data processing agent (106) is configured to transmit upstream data packets at an upstream data fidelity level and to receive downstream data packets at a downstream data fidelity level from the SED data processing agent (110). Similarly, the SED data processing agent (110) is configured to receive the upstream data packets at the upstream data fidelity level and to transmit the downstream data packets at the downstream data fidelity level.

The FED (102) also includes an FED flow control agent (108), and the SED (104) includes a corresponding SED flow control agent (112). Each of the FED flow control agent (108) and the SED flow control agent (112) are computer implemented software components that are configured to manage change requests such as change requests (116) (shown and described in FIG. 1B) and, optionally, send and receive acknowledgement packets such as the acknowledgement packets (126).

In one-way data flows, the FED flow control agent (108) is configured to receive SED messages such as messages (114) (shown and described in FIG. 1B), which may include the change request (116) and a requested data fidelity level. The FED flow control agent (108) is also configured to determine whether to accept or deny the requested data fidelity level and to transmit a message, which may also be the message (114) with a success response or a failure response such as the success response or failure response (118) (shown and described in FIG. 1B). The SED flow control agent (112) is configured to transmit messages having the change request with the requested data fidelity level.

In two-way data flows, the FED flow control agent (108) is configured to transmit one or more FED messages having at least a FED change request and a requested downstream data fidelity level. The FED flow control agent (108) is also configured to receive SED messages from the SED flow control agent (112) having at least a SED change request and a requested upstream data fidelity level and determine whether to accept or deny the requested upstream data fidelity level. The FED flow control agent (108) is also configured transmit FED messages having a success response or a failure response.

In the two-way data flows, the SED flow control agent (112) is configured to transmit the SED messages having at least the SED change request and the requested upstream data fidelity level to the FED flow control agent (108). The SED flow control agent (112) is also configured to receive the FED messages having FED change request and the requested downstream data fidelity level and determine whether to accept or deny the requested downstream data fidelity level. The SED flow control agent (112) is also configured transmit one or more SED messages having the success response or the failure response.

In any embodiment (e.g., one-way data flow, two-way data flow, etc.) where data is “chunked”, the data fidelity level may be adjusted at chunk boundaries. Generally, “chunking” refers to the process of breaking down large amounts of data into smaller, more manageable pieces (“chunks”) for transmission or processing. Chunking enables a data stream to be divided such that each chunk is transmitted at a single, consistent data fidelity level as changes to the data fidelity level may occur at chunk boundaries and not within an individual chunk.

The system (100) can include more or less components than shown. For example, the system (100) can include components for any type of network that may include the FED (102) and the SED (104), such as, for example, a telecommunication network.

Turning to FIGS. 1B, 1C, and 1D block diagrams of the message (114), the data packet (120), and the acknowledgement packet (126), are respectively shown. The messages (114), the data packets (120), and the acknowledgement packets (126) are transmitted and received by the FED (102) and the SED (104) and more specifically, the messages (114) are transmitted and received by the FED flow control agent (108) and the SED flow control agent (112) and the data packets (120) are transmitted and received by the FED data processing agent (106) and the SED data processing agent (110). The acknowledgement packets (126) can be transmitted and received by the FED data processing agent (106), the FED flow control agent (108), the SED data processing agent (110), and/or the SED flow control agent (112).

The messages (114) are information formatted or structured for transmission between the FED flow control agent (108) and the SED flow control agent (112). The messages (114) can include the change request (116) or the success response or failure response (118). The messages (114) can also include other content such as, for example, one or more headers, metadata, identifiers, or other fields.

The change request (116) includes a request to change the data fidelity level of data packets (120) being received by an endpoint device (whether the FED (102) or the SED (104)). For example, the FED flow control agent (108) may request a different downstream data fidelity level for downstream data packets (120) received by the FED data processing agent (106) via the change request (116). In another example, the SED flow control agent (112) may request a different upstream data fidelity level for upstream data packets (120) received by the SED data processing agent (110) via the change request (116).

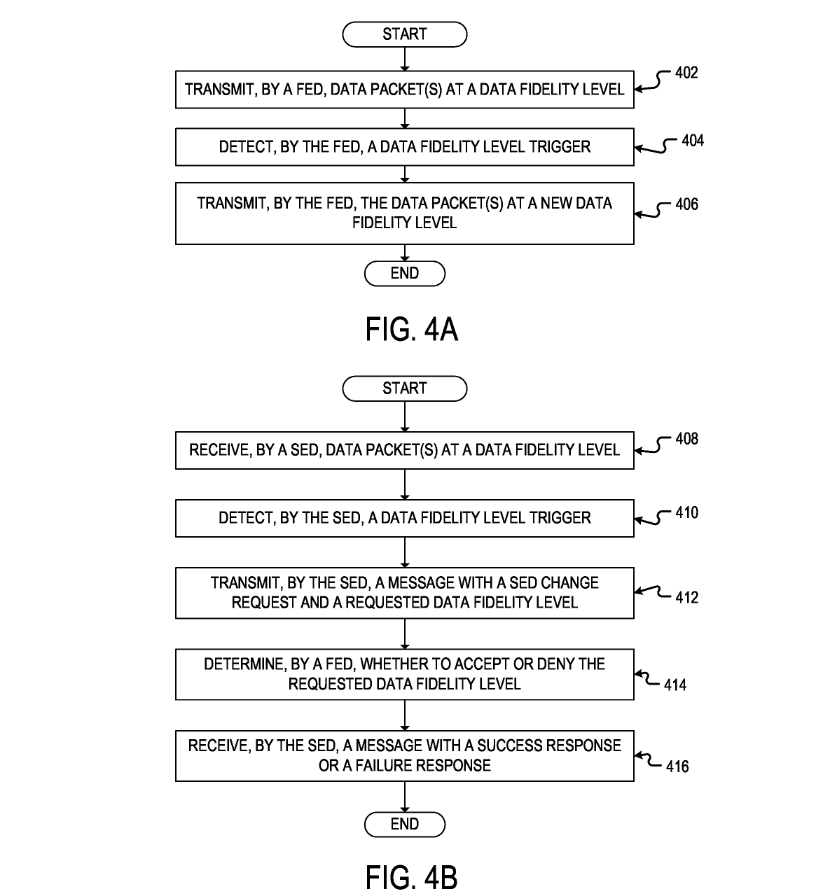

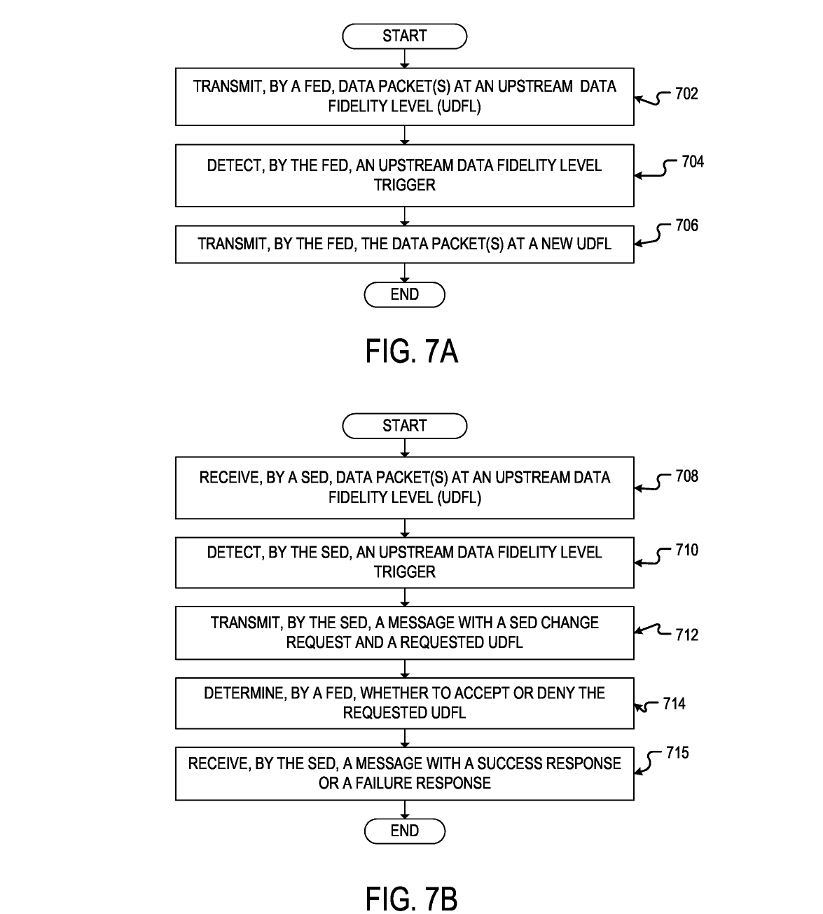

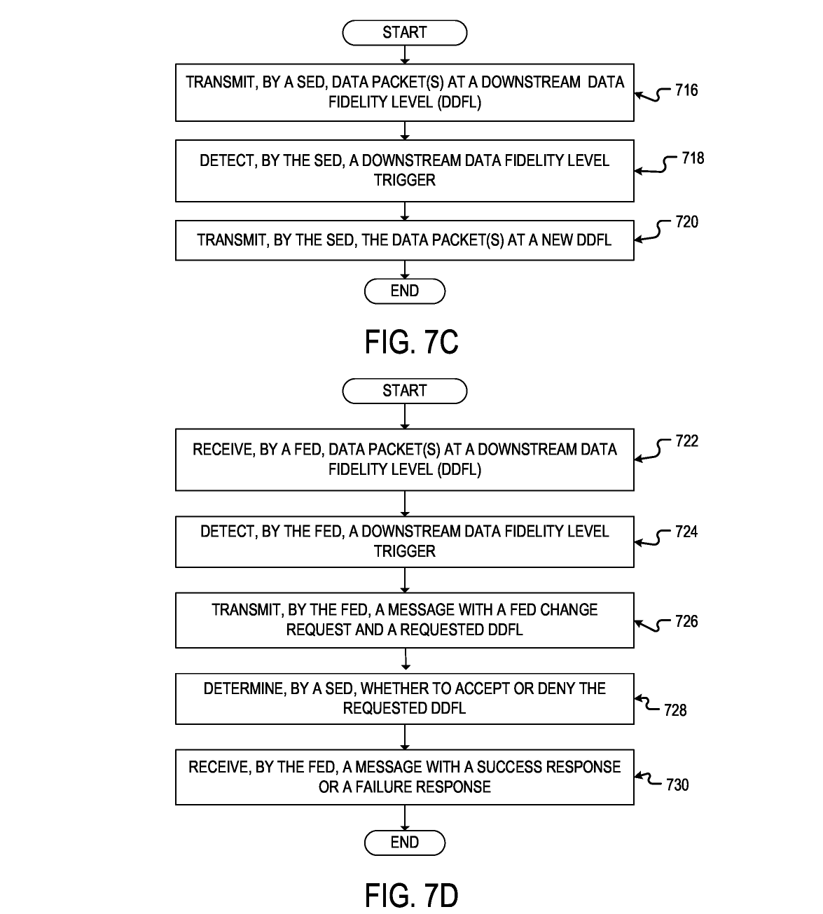

The success response or failure response (118) are generated based on whether the change request (116) is accepted or denied by the receiving agent (e.g. the FED flow control agent (108) or the SED flow control agent (112)). If the change request (116) is accepted, the success response is generated, and if the change request (116) is denied, the failure response is generated. Determining whether to accept or deny the change request (116) is described in detail in FIGS. 4B, 7B, and 7D.

The data packet (120) includes a data payload (124) and a header (122). In at least one embodiment, the header (122) includes data fidelity level information (DFLI) (132) associated with the data payload (124). The format of the DFLI (132) in the header (122) may vary by application. For example, the DFLI (132) may be represented as a simple enumerated value or may be encoded in a more complex structure. More generally, the DFLI (132) is formatted such that both the FED data processing agent (106) and the SED data processing agent (110) can interpret the header (122) and determine the applicable data fidelity level from the DFLI (132).

The data payload (124) includes the substantive data being transmitted. The data payload (124) can include, for example, raw data, encoded data, compressed data, application-level content, or any information intended for processing, storage, analysis, or interpretation by a receiving entity. The data payload (124) may also be, for example, audio data, visual data, streaming data, etc. The structure, format, and interpretation of the data payload (124) varies by application.

The acknowledgement packet (126) is transmitted by a receiving entity (whether the FED data processing agent (106), the FED flow control agent (108), the SED data processing agent (110), and/or the SED flow control agent (112)) to indicate that one or more previously received data packets (120) and/or messages (114) were successfully received, processed, or otherwise recognized. The acknowledgement packet (126) may be generated automatically or in response to protocol‑specific conditions and may be optional, depending on the application. The acknowledgement packet (126) may include information such as acknowledgement information (130) identifying the data being acknowledged and/or the DFLI (128) identifying the data fidelity level at which the data was received.

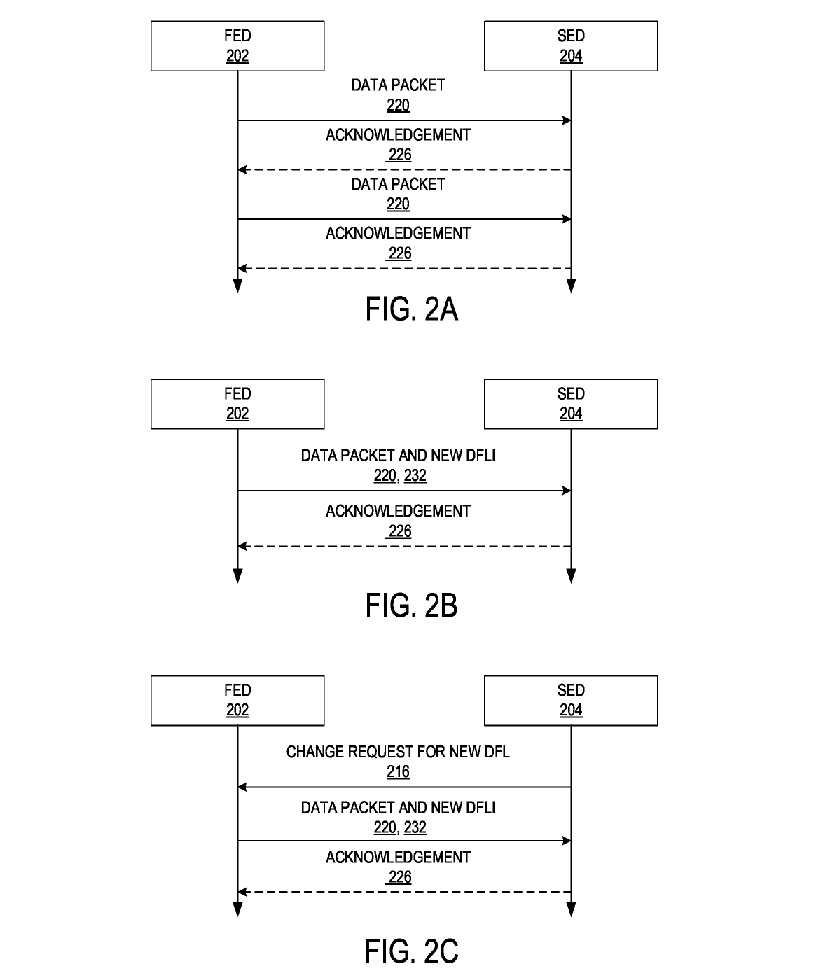

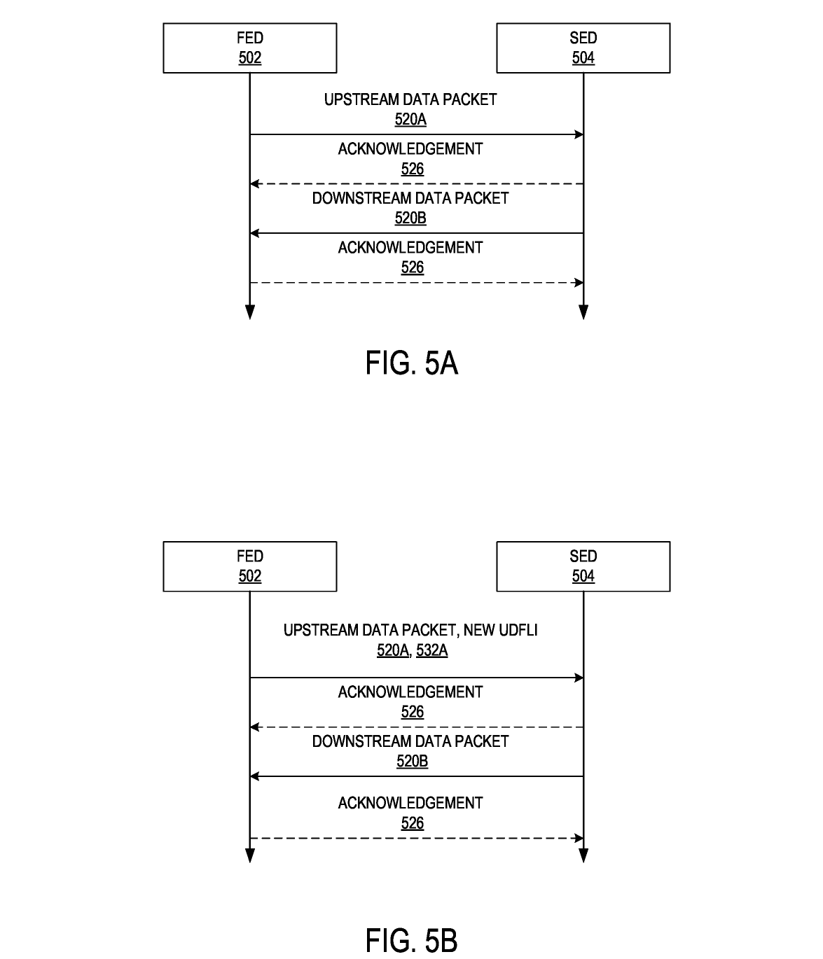

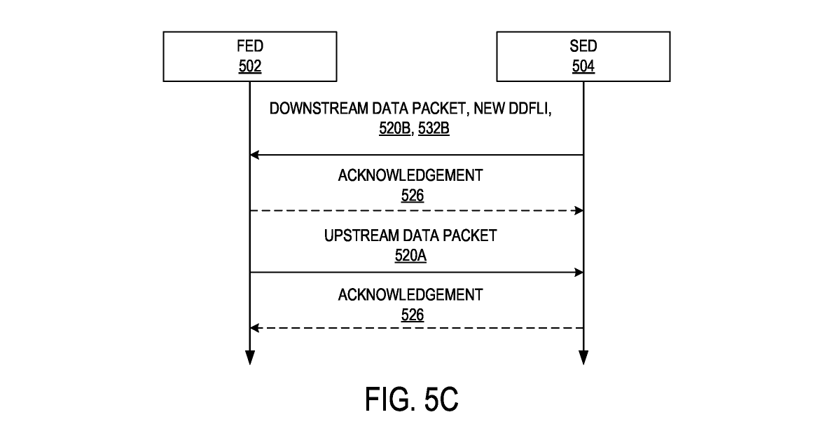

Turning to FIGS. 2A, 2B, 2C, 3, 4A, and 4B, the system (100) with a one-way data flow will be described. FIGS. 5A, 5B, 5C, 6A, 6B, 7A, 7B, 7C, and 7D describe the system (100) with a two-way data flow. The embodiments described (one-way data flow and two-way data flow) are merely example embodiments of the system (100) and illustrate example implementations of the system (100). It will be appreciated that the system (100) can extend to any form, type, or number of data flows.

FIGS. 2A, 2B, and 2C are each a message flow for a one-way data flow of a dynamic data fidelity level adjustment system, such as the system (100), and illustrate when a FED (202) and a SED (204) establish a connection, when the FED (202) changes a data fidelity level, and when the SED (204) request to change the data fidelity level, respectively.

FIG. 2A illustrates the message flow for when the FED (202) and the SED (204) establish a connection. The FED (202) and the SED (204) may be the same as or similar to the FED (102) and the SED (104), respectively. Generally, when the connection is established between the FED (202) and the SED (204) in a one-way data flow, the FED (202) sends data packets (220) (which may be the same as or similar to the data packets (120)) at a data fidelity level. The data packets (220) can include a header with DFLI, such as the DFLI (132), corresponding to the data fidelity level. The SED (204) may optionally return an acknowledgement packet (226) (which may be the same as or similar to the acknowledgement packet (126)) to acknowledge receipt of the data packet (220).

FIG. 2B illustrates the message flow for when the FED (202) changes the data fidelity level. As shown, when the FED (202) changes the data fidelity level (due to, for example, detecting a data fidelity trigger such as a change in network performance or reliability), the FED (202) simply changes the DFLI (232) in the next data packet (220) and transmits the data packet (220) at the new data fidelity level to the SED (204). The SED may optionally return the acknowledgement packet (226) to acknowledge receipt of the data packet (220) and the new DFLI (232).

FIG. 2C illustrates the message flow for when the SED (204) changes the data fidelity level. As shown, when the SED (204) changes the data fidelity level, the SED (204) sends a change request (216) for a requested data fidelity level to the FED (202). If the FED (202) accepts the change request (216), the FED (202) sends the next data packet (220) with a new DFLI (232) reflecting the requested data fidelity level. The SED (204) may optionally return the acknowledgement packet (226) to acknowledge receipt of the data packet (220) and the new DFLI (232). Though not shown, if the FED (202) denies the change request (216), a message such as the message (114) with a failure response is returned to the SED (204) from the FED (202) and the data fidelity level is not adjusted. In such instances, the SED (204) may send another change request (216) with a different requested data fidelity level to the FED (202) until a requested data fidelity level is accepted.

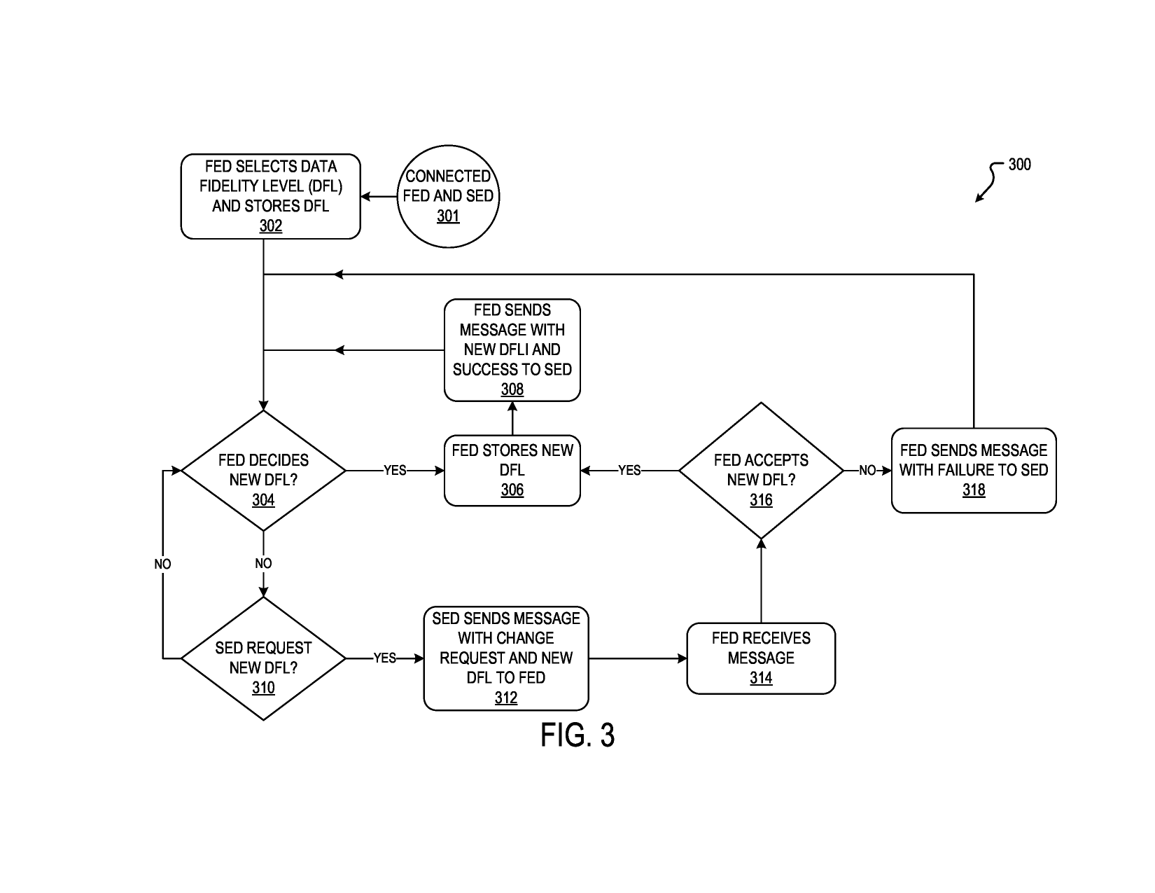

FIG. 3 is a logic flow (300) of a one-way data flow of a dynamic data fidelity level adjustment system, such as the system (100), according to at least one embodiment of the present disclosure. As shown, the logic flow (300) begins with an FED (such as the FED (102), (202)) and an SED (such as the SED (104), (204)) connecting (301) and the FED selecting a data fidelity level (DFL) and storing the DFL (302).

The logic flow (300) includes a first decision tree (304) where the decision tree is based on whether the FED decides a new DFL. If the FED decides a new DFL, the logic flow (300) follows the “YES” branch and the FED simply stores the new DFL (306) and sends a message with a success response such as the success response (118) to the SED (308). In some embodiments, the FED may not send the message with the success response to the SED. In other words, the step (308) may not occur and the FED may simply store the new DFL. In any instance, the logic flow (300) then returns to the first decision tree (304).

If the FED does not decide on a new DFL, the logic flow (300) follows the “NO” branch to a second decision tree (310) based on whether the SED requests a new DFL. If the SED does not request a new DFL (310), the logic flow (300) returns to the first decision tree (304). If the SED does request a new DFL (310), the logic flow (300) follows the “YES” branch and the SED sends a message such as the message (114) with a change request such as the change request (116), (216) requesting a new DFL to the FED (312). The FED then receives the message (314), and the logic flow (300) moves to a third decision tree (316) based on whether the FED accepts the new DFL or denies the new DFL. If the FED denies the new DFL, then the FED sends a message with a failure response, such as the failure response (118) to the SED (318). The logic flow (300) then returns to the first decision tree (304).

Returning to the third decision tree (316), if the FED accepts the new DFL, then the FED stores the new DFL (306) and sends a message with the success response to the SED (308). The logic flow (300) then returns to the first decision tree (304).

FIG. 4A is a flowchart of a method according to at least one embodiment of the present disclosure. The method is for a one-way data flow of a dynamic data fidelity level adjustment system such as the system (100). More specifically, the method describes adjusting a data fidelity level at a FED such as the FED (102), (202). The method can be performed using, for example, the system (100) and may implement the logic flow (300).

Step 402 of the method provides for transmitting, by the FED, data packets at a data fidelity level. The data packets may be the same as or similar to the data packets (120), which may include a header such as the header (122) and a DFLI such as the DFLI (132) describing the data fidelity level. The data packets may be transmitted to a SED such as the SED (104), (204).

Step 404 of the method provides for detecting, by the FED, a data fidelity level trigger. The data fidelity trigger may be a change in network performance, condition, or reliability that affects the data fidelity of the data packets being transmitted. In other words, the data fidelity trigger correlates to a level of degradation in the network that results in a lag and/or loss of data packets. Examples of the data fidelity trigger include, but are not limited to, changes in network throughput, network latency, network jitter, computational capacity, etc. The data fidelity trigger can be detected when the data fidelity trigger (e.g., network latency, network jitter, etc.) meet or exceed a predetermined data fidelity threshold. The predetermined data fidelity threshold may be set at values where, for example, the system performance at the current data fidelity level becomes non-optimal.

Step 406 of the method provides for transmitting, by the FED, the data packets at a new data fidelity level. The FED can simply send data packets with a new DFLI header with the new data fidelity level at the new data fidelity level to the SED. The new data fidelity level is based on the data fidelity trigger detected in the step 404. More specifically, the new data fidelity level may be selected to preserve one or more data fidelity properties such as, for example, data resolution or data rate. For example, data resolution may be reduced to preserve the data rate such that data is transmitted at the same data rate, but at a lower data resolution. In such example, data resolution may be sacrificed to preserve the data rate.

The new data fidelity level may also be based on limitations (whether software or hardware) of the FED and/or the SED. For example, the new data fidelity level may include reduced data rates so as to reduce power used by the FED to transmit the data packets, thereby reducing heat generated and emitted by the FED. In another example, the new data fidelity level may be based on whether the FED or the SED are able to compress data for transmittal (e.g., reduce a size of the data for transmittal) or decompress transmitted data within a target timeframe that would satisfy the new data fidelity level. In such example, if the FED or the SED cannot perform compression and decompression within the target timeframe, a different data fidelity level may be selected so as to accommodate compression and decompression.

FIG. 4B is a flowchart of a method according to at least one embodiment of the present disclosure. The method is for a one-way data flow of a dynamic data fidelity level adjustment system such as the system (100). More specifically, the method describes adjusting a data fidelity level by a SED such as the SED (104), (204). The method can be performed using, for example, the system (100) and may implement the logic flow (300).

Step 408 of the method provides for receiving, by the SED, data packets at a data fidelity level. The data packets may be the same as or similar to the data packets (120), which may include a header such as the header (122) and a DFLI such as the DFLI (132) describing the data fidelity level at which the data packets were transmitted. The data packets may be transmitted by a FED such as the FED (102), (202).

Step 410 of the method provides for detecting, by the SED, a data fidelity level trigger. The step 410 may be the same as or similar to the step 404 of FIG. 4A, described above, except that the data fidelity level trigger is detected by the SED.

Step 412 of the method provides for transmitting, by the SED, a message with a SED change request and a requested data fidelity level. The requested data fidelity level may be based on the same factors as the new data fidelity level selected by the FED in the step 406 of FIG. 4A, described above. For example, the requested data fidelity level may be based on the data fidelity trigger detected in the step 410 and may be selected to preserve one or more data fidelity properties such as, for example, data resolution or data rate. The requested data fidelity level may also be based on limitations (whether software or hardware) of the FED and/or the SED.

Step 414 of the method provides for determining, by the FED, whether to accept or deny the requested data fidelity level. Determining whether to accept or deny the requested data fidelity level is based on whether the FED can accommodate the requested data fidelity level. For example, the FED may be constrained at a software level and/or a hardware level such that the FED may not be able to accommodate the requested data fidelity level. In another example, the FED may not be able to accept the requested data fidelity level due to the data fidelity level not being available to the FED, the FED avoiding or unable to use enough power to send data packets at the requested data fidelity level, the FED lacking processing power to send data packets at the requested data fidelity level, or the FED lacking the ability to compress the data to achieve the requested data fidelity level at the available data transmission rate.

Step 416 of the method provides for receiving, by the SED, a message with a success response or a failure response. The success response or the failure response may be the same as or similar to the success response or the failure response (118). The message with a success response is received when the FED determines to accept the requested fidelity level. The message with a failure response is received when the FED determines to deny or reject the requested fidelity level.

The methods described in FIG. 4A and FIG. 4B can include more or less steps. One or more steps or any combination of steps may also be repeated in the methods described in FIG. 4A and 4B.

Turning to FIGS. 5A, 5B, 5C, 6A, 6B, 7A, 7B, 7C, and 7D the system (100) with a two-way data flow is described. Generally, the two-way data flow is similar to the one-way data flow, except that data packets are transmitted and received by both the FED (102), (502) and the SED (104), (504), and both the FED (102), (502) and the SED (104), (504) can request changes to the data fidelity level of respective data packets received at the FED (102), (502) and the SED (104), (504). In the embodiments described below, downstream refers to data transmission from the SED to the FED and upstream refers to data transmission from the FED to the SED.

FIGS. 5A, 5B, and 5C are each a message flow for a two-way data flow of a dynamic data fidelity level adjustment system, such as the system (100), and illustrate when a FED (502) and a SED (504) establish a connection, when the FED (502) changes an upstream data fidelity level, and when the SED (504) changes a downstream data fidelity level, respectively.

FIG. 5A illustrates the message flow for when the FED (502) and the SED (504) establish a connection. The FED (502) and the SED (504) may be the same as or similar to the FED (102) and the SED (104), respectively. Generally, when the connection is established between the FED (502) and the SED (504) in a two-way data flow, the FED (502) sends upstream data packets (520A) (which may be the same as or similar to the data packets (120)) at an upstream data fidelity level. The upstream data packets (520A) can include a header with upstream DFLI (UDFLI) corresponding to the upstream data fidelity level. The SED (504) may optionally return an acknowledgement packet (526) (which may be the same as or similar to the acknowledgement packet (126)) to acknowledge receipt of the upstream data packet (520A).

Similarly, the SED (504) may transmit downstream data packets (520B) (which may be the same as or similar to the data packets (120)) at a downstream data fidelity level. The downstream data packets (520B) can also include a header with downstream DFLI (DDFLI) corresponding to the downstream data fidelity level. The FED (502) may optionally return an acknowledgement packet (526) (which may be the same as or similar to the acknowledgement packet (126)) to acknowledge receipt of the downstream data packets (520B).

FIG. 5B illustrates the message flow for when the FED (502) changes the upstream data fidelity level. As shown, when the FED (502) changes the upstream data fidelity level (due to, for example, an upstream data fidelity trigger such as a change in network performance or reliability), the FED (502) simply changes a UDFLI (532A) in the next upstream data packet (520A) and transmits the upstream data packet (520A) at the new upstream data fidelity level to the SED (504). The SED (504) may optionally return the acknowledgement packet (526) to acknowledge receipt of the upstream data packet (520A) and the new UDFLI (532A). The SED (504) may also continue to send downstream data packets (520B) at the downstream data fidelity level, as only the upstream data fidelity level was changed.

FIG. 5C illustrates the message flow for when the SED (504) changes the downstream data fidelity level. As shown, when the SED (504) changes the downstream data fidelity level (due to, for example, a downstream data fidelity trigger such as a change in network performance or reliability), the SED (504) also simply changes a DDFLI (532B) in the next downstream data packet (520B) and transmits the downstream data packet (520B) at the new downstream data fidelity level to the FED (502). The FED (502) may optionally return the acknowledgement packet (526) to acknowledge receipt of the downstream data packet (520B) and the new DDFLI (532B). The SED (504) may also continue to send upstream data packets (520A) at the upstream data fidelity level, as only the downstream data fidelity level was changed.

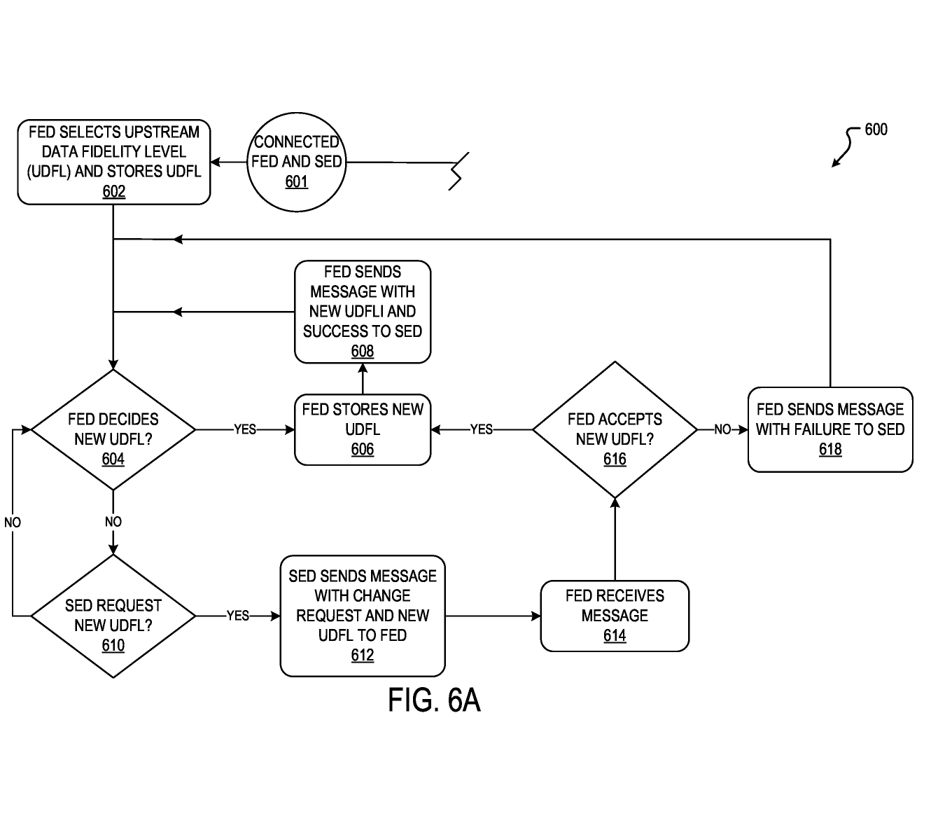

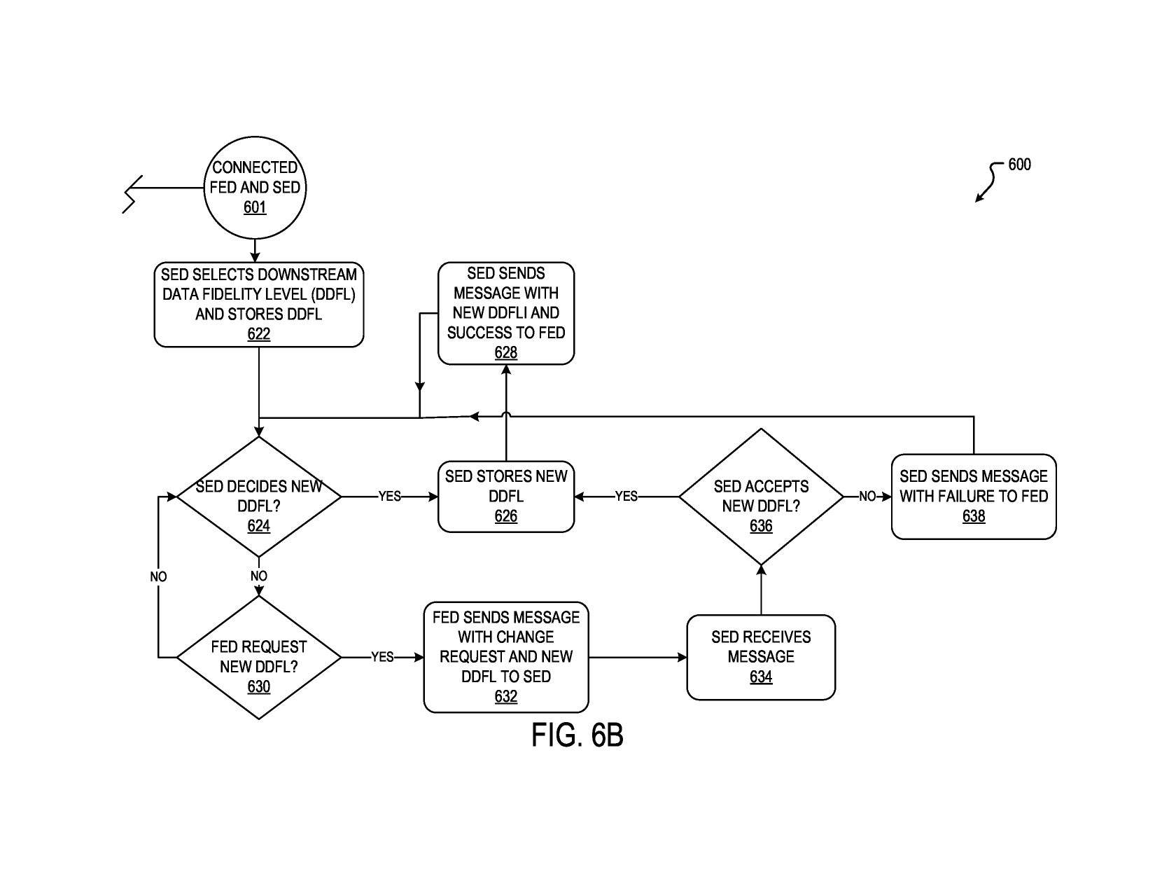

FIG. 6A illustrates a first portion of a logic flow (600) of a two-way data flow of a dynamic data fidelity level adjustment system, such as the system (100), according to at least one embodiment of the present disclosure. FIG. 6A illustrates the logic flow (600) for adjusting an upstream data fidelity level by a FED or a SED.

As shown, the logic flow (600) begins with a FED (such as the FED (102), (502)) and a SED (such as the SED (104), (504)) connecting (601) and the FED selecting an upstream data fidelity level (UDFL) and storing the UDFL (602).

The logic flow (600) includes a first decision tree (604) where the decision tree is based on whether the FED decides on a new UDFL. If the FED decides on a new UDFL, the logic flow (600) follows the “YES” branch and the FED simply stores the new UDFL (606) and sends a message with a success response such as the success response (118) to the SED (608). In some embodiments, the FED may not send the message with the success response to the SED. In other words, the step (608) may not occur and the FED may simply store the new UDFL. In any instance, the logic flow (600) then returns to the first decision tree (604).

If the FED does not decide on a new UDFL, the logic flow (600) follows the “NO” branch to a second decision tree (610) based on whether the SED requests a new UDFL. If the SED does not request a new UDFL (610), the logic flow (600) returns to the first decision tree (604). If the SED does request a new UDFL (610), the logic flow (600) follows the “YES” branch and the SED sends a message such as the message (114) with a change request such as the change request (116) requesting the new UDFL to the FED (612). The FED then receives the message (614), and the logic flow (600) flows to a third decision tree (616) based on whether the FED accepts the new UDFL or denies the new UDFL. If the FED denies the new UDFL, then the FED sends a message with a failure response, such as the failure response (118) to the SED (618). The logic flow (600) then returns to the first decision tree (604).

Returning to the third decision tree (616), if the FED accepts the new UDFL, then the FED stores the new UDFL (606) and sends a message with the success response to the SED (608). The logic flow (600) then returns to the first decision tree (604).

FIG. 6B illustrates a second portion of the logic flow (600), according to at least one embodiment of the present disclosure. FIG. 6B continues from FIG. 6A and illustrates the logic flow (600) for adjusting a downstream data fidelity level by the FED or the SED.

As shown, the logic flow (600) includes the SED selecting a downstream data fidelity level (DDFL) and storing the DDFL (622). The logic flow (600) also includes a fifth decision tree (624) where the decision tree is based on whether the SED decides on a new DDFL. If the SED decides on a new DDFL, the logic flow (600) follows the “YES” branch and the SED simply stores the new DDFL (626) and sends a message with a success response such as the success response (118) to the FED (628). In some embodiments, the SED may not send the message with the success response to the FED. In other words, the step (628) may not occur and the SED may simply store the new DDFL. In any instance, the logic flow (600) then returns to the first decision tree (624).

If the SED does not decide on a new DDFL, the logic flow (600) follows the “NO” branch to a sixth decision tree (630) based on whether the FED requests a new DDFL. If the FED does not request a new DDFL, the logic flow (600) returns to the fifth decision tree (624). If the FED does request a new DDFL, the logic flow (600) follows the “YES” branch and the FED sends a message such as the message (114) with a change request such as the change request (116) requesting the new DDFL to the SED (632).

The SED then receives the message (634), and the logic flow (600) flows to a seventh decision tree (636) based on whether the SED accepts the new DDFL or denies the new DDFL. If the SED denies the new DDFL, then the SED sends a message with a failure response, such as the failure response (118) to the FED (638). The logic flow (600) then returns to the fifth decision tree (624).

Returning to the seventh decision tree (636), if the SED accepts the new DDFL, then the SED stores the new DDFL (626) and sends a message with the success response to the FED (628). The logic flow (600) then returns to the fifth decision tree (624).

In some embodiments, the SED may request a new UDFL and the FED may request a new DDFL simultaneously or concurrently. In other words, the logic flow (600) shown on FIGS. 6A and 6B may occur simultaneously.

FIG. 7A is a flowchart of a method according to at least one embodiment of the present disclosure. The method is for a two-way data flow of a dynamic data fidelity level adjustment system such as the system (100). More specifically, the method describes adjusting an upstream data fidelity level at a FED such as the FED (102), (502). The method can be performed using, for example, the system (100) and may implement the logic flow (600).

Step 702 of the method provides for transmitting, by the FED, data packets at an upstream data fidelity level. The upstream data packets may be the same as or similar to the data packets (120) or upstream data packets (520A), which may include a header such as the header (122) and an UDFLI such as the UDFLI (532A) describing the upstream data fidelity level. The upstream data packets may be transmitted to a SED such as the SED (104), (204).

Step 704 of the method provides for detecting, by the FED, an upstream data fidelity level trigger. The step 704 may be the same as or similar to the step 404 of FIG. 4A, described above.

Step 706 of the method provides for transmitting, by the FED, the upstream data packets at a new upstream data fidelity level. The FED can simply send upstream data packets with a new UDFLI header at the new upstream data fidelity level to the SED. The new upstream data fidelity level is based on the upstream data fidelity trigger detected in the step 704. As previously described, the new upstream data fidelity level may be selected to preserve one or more upstream data fidelity properties such as, for example, data resolution or data rate. The new upstream data fidelity level may also be based on limitations (whether software or hardware) of the FED and/or the SED.

FIG. 7B is a flowchart of a method according to at least one embodiment of the present disclosure. The method is for a two-way data flow of a dynamic data fidelity level adjustment system such as the system (100). More specifically, the method describes adjusting an upstream data fidelity level at a SED such as the SED (104), (204). The method can be performed using, for example, the system (100) and may implement the logic flow (600).

Step 708 of the method provides for receiving, by the SED, upstream data packets at an upstream data fidelity level. The data packets may be the same as or similar to the data packets (120) or the upstream data packets (520A), which may include a header such as the header (122) and an UDFLI such as the UDFLI (532A) describing the upstream data fidelity level at which the upstream data packets were transmitted. The upstream data packets may be transmitted by a FED such as the FED (102), (202).

Step 710 of the method provides for detecting, by the SED, an upstream data fidelity level trigger. The step 710 may be the same as or similar to the step 404 of FIG. 4A, described above, except that an upstream data fidelity level trigger is detected by the SED.

Step 712 of the method provides for transmitting, by the SED, a message with a SED change request and a requested upstream data fidelity level. The message may be the same as or similar to the message (114) and the change request may be the same as or similar to the change request (116). The requested upstream data fidelity level may be based on the same factors as the new upstream data fidelity level selected by the FED in the step 406 of FIG. 4A, described above.

Step 714 of the method provides for determining, by the FED, whether to accept or deny the requested upstream data fidelity level. The step 714 may be the same as or similar to the step 414 of FIG. 4B, described above.

Step 715 of the method provides for receiving, by the SED, a message with a success response or a failure response. The success response or the failure response may be the same as or similar to the success response or the failure response (118). The message with a success response is received when the FED determines to accept the requested upstream fidelity level. The message with a failure response is received when the FED determines to deny or reject the requested upstream fidelity level.

The methods described in FIGS. 7A and 7B can include more or less steps. One or more steps or any combination of steps may also be repeated in the methods described in FIG. 7A and 7B.

FIG. 7C is a flowchart of a method according to at least one embodiment of the present disclosure. The method is for a two-way data flow of a dynamic data fidelity level adjustment system such as the system (100). More specifically, the method describes adjusting a downstream data fidelity level at a SED such as the SED (104), (504). The method can be performed using, for example, the system (100) and may implement the logic flow (600). The method of FIG. 7C is generally the same as or similar to method of the FIG. 7A, except that a downstream data fidelity level is adjusted by the SED.

Step 716 of the method provides for transmitting, by the SED, data packets at a downstream data fidelity level. The downstream data packets may be the same as or similar to the data packets (120) or downstream data packets (520B), which may include a header such as the header (122) and a DDFLI such as the DDFLI (532B) describing the downstream data fidelity level. The downstream data packets may be transmitted to a FED such as the FED (102), (202).

Step 718 of the method provides for detecting, by the SED, a downstream data fidelity level trigger. The step 718 may be the same as or similar to the step 404 of FIG. 4A, described above, except that the SED detects the downstream data fidelity level trigger.

Step 720 of the method provides for transmitting, by the SED, the downstream data packets at a new downstream data fidelity level. The SED can simply send downstream data packets with a new DDFLI header at the new downstream data fidelity level to the FED. The new downstream data fidelity level is based on the downstream data fidelity trigger detected in the step 718. The new downstream data fidelity level may be based on the same factors as the new upstream data fidelity level described in step 406 of FIG. 4A.

FIG. 7D is a flowchart of a method according to at least one embodiment of the present disclosure. The method is for a two-way data flow of a dynamic data fidelity level adjustment system such as the system (100). More specifically, the method describes adjusting a downstream data fidelity level at a FED such as the FED (102), (202). The method can be performed using, for example, the system (100) and may implement the logic flow (600). The method of FIG. 7D is generally the same as or similar to method of the FIG. 7B, except that a downstream data fidelity level is adjusted by the FED.

Step 722 of the method provides for receiving, by the FED, downstream data packets at a downstream data fidelity level. The data packets may be the same as or similar to the data packets (120) or the downstream data packets (520B), which may include a header such as the header (122) and a DDFLI such as the DDFLI (532B) describing the downstream data fidelity level at which the downstream data packets were transmitted. The downstream data packets may be transmitted by a SED such as the SED (104), (204).

Step 724 of the method provides for detecting, by the FED, a downstream data fidelity level trigger. The step 724 may be the same as or similar to the step 404 of FIG. 4A, described above.

Step 726 of the method provides for transmitting, by the FED, a message with a FED change request and a requested downstream data fidelity level. The message may be the same as or similar to the message (114) and the FED change request may be the same as or similar to the change request (116). The requested downstream data fidelity level may be based on the same factors as described in the step 406 of FIG. 4A, described above.

Step 728 of the method provides for determining, by the SED, whether to accept or deny the requested downstream data fidelity level. The step 728 may be the same as or similar to the step 414 of FIG. 4B, described above.

Step 730 of the method provides for receiving, by the FED, a message with a success response or a failure response. The success response or the failure response may be the same as or similar to the success response or the failure response (118). The message with a success response is received when the SED determines to accept the requested downstream fidelity level. The message with a failure response is received when the SED determines to deny or reject the requested downstream fidelity level.

The methods described in FIGS. 7C and 7D can include more or less steps. One or more steps or any combination of steps may also be repeated in the methods described in FIG. 7C and 7D.

In some embodiments of the dynamic data fidelity adjustment systems and methods as described herein, a data fidelity negotiation may employ a counter-offer mechanism in which a denial of a requested data fidelity level includes one or more alternative fidelity levels proposed by the responding endpoint device, thereby enabling iterative negotiation. In further embodiments, data fidelity levels may be adjusted proactively based on predictive techniques, including machine-learning-based forecasting of network conditions or endpoint constraints, prior to detection of a data fidelity trigger. In still further embodiments, data payloads may be transmitted using priority-tiered fidelity control, wherein only designated critical subsets of data are transmitted at reduced fidelity while non-critical data is deferred or omitted, including in latency-sensitive applications such as autonomous vehicle systems.

The dynamic data fidelity adjustment systems and methods as described herein provide a flexible mechanism for dynamically adjusting a data fidelity level of transmitted data (whether one-way, upstream, or downstream, or any number of directions), allowing timely transfer even when network conditions degrade and bandwidth becomes insufficient, or sender and/or receiver processing conditions change (e.g., changes to power requirements, compression or decompression capabilities, etc.). Unlike existing systems that rely on static configurations, the systems and methods of the present disclosure ensure that data continues to flow effectively under changing throughput, latency, or computational constraints. The systems and methods also support both one-way and two-way data flow scenarios, enabling, for example, either entity in a sender–receiver or client–server pair to request or respond to changes in data fidelity, even when upstream and downstream conditions differ. Generally, the systems and methods as described herein enhance adaptability and robustness of data transfer in a network by enabling dynamic negotiation of fidelity levels, thereby reducing delays and failures, and allowing networks to operate effectively even when lower-fidelity data is sufficient for an intended task.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, i.e., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A dynamic data fidelity level adjustment system, the system comprising:
a first endpoint device (FED) comprising:
a FED data processing agent configured to transmit one or more data packets at a data fidelity level; and
a FED flow control agent configured to at least one of (i) receive one or more second endpoint device (SED) messages, (ii) determine whether to accept or deny a requested data fidelity level when the one or more SED messages are received, and (iii) transmit one or more FED messages having a success response or a failure response; and
the SED comprising:
a SED data processing agent configured to receive one or more data packets at a data fidelity level; and
a SED flow control agent configured to transmit the one or more SED messages having at least a SED change request with the requested data fidelity level,
wherein the SED transmits the one or more SED messages to the FED when a data fidelity level trigger occurs and the FED determines whether to accept or deny the requested data fidelity level, and
wherein the FED transmits the one or more data packets at a new data fidelity level when the data fidelity level trigger occurs.

2. The dynamic data fidelity level adjustment system of claim 1, wherein the FED flow control agent transmits the one or more FED messages when the FED determines whether to accept or deny the requested data fidelity level.

3. The dynamic data fidelity level adjustment system of claim 2, wherein the one or more FED messages includes at least one of a success response when the FED determines to accept the requested data fidelity level or a failure response when the FED determines to deny the requested data fidelity level.

4. The dynamic data fidelity level adjustment system of claim 1, wherein the FED flow control agent determines whether to accept or deny the requested data fidelity level based on at least one of processing power, device power, device capabilities, or network conditions.

5. The dynamic data fidelity level adjustment system of claim 1, wherein the requested data fidelity level is based on the data fidelity level trigger.

6. The dynamic data fidelity level adjustment system of claim 1, wherein the dynamic data fidelity level adjustment system is a one-way data flow system.

7. The dynamic data fidelity level adjustment system of claim 1, wherein the SED data processing agent is further configured to transmit an acknowledgement packet when the FED transmits the one or more FED messages having the success response or the failure response.

8. The dynamic data fidelity level adjustment system of claim 1, wherein each data packet of the one or more data packets includes a header and a data payload.

9. The dynamic data fidelity level adjustment system of claim 8, wherein the header includes data fidelity level information corresponding to the data fidelity level at which the data packet was transferred.

10. A dynamic data fidelity level adjustment system, the system comprising:
a first endpoint device (FED) comprising:
a FED data processing agent configured to transmit one or more upstream data packets at an upstream data fidelity level and to receive one or more downstream data packets at a downstream data fidelity level; and
a FED flow control agent configured to at least one of (i) transmit one or more FED messages having at least a FED change request and a requested downstream data fidelity level, (ii) receive one or more second endpoint device (SED) messages having at least a SED change request and a requested upstream data fidelity level, (iii) determine whether to accept or deny the requested upstream data fidelity level when the one or more SED messages are received, and (iv) transmit one or more FED messages having a success response or a failure response,
the SED comprising:
a SED data processing agent configured to transmit the one or more downstream data packets at the downstream data fidelity level and to the receive one or more upstream data packets at the upstream data fidelity level; and
a SED flow control agent configured to at least one of (i) transmit the one or more SED messages having at least the SED change request and the requested upstream data fidelity level, (ii) receive the one or more FED messages having at least the FED change request and the requested downstream data fidelity level, (iii) determine whether to accept or deny the requested downstream data fidelity level when the one or more FED messages are received, and (iv) transmit one or more SED messages having the success response or the failure response,
wherein the SED transmits the one or more SED messages to the FED when an upstream data fidelity level trigger occurs and the FED determines whether to accept or deny the requested new upstream data fidelity level,
wherein the FED transmits the one or more upstream data packets at a new upstream data fidelity level when the upstream data fidelity level trigger occurs,
wherein the FED transmits the one or more FED messages to the SED when a downstream data fidelity level trigger occurs and the SED determines whether to accept or deny the requested new downstream data fidelity level, and
wherein the SED transmits the one or more downstream data packets at a new downstream data fidelity level when the downstream data fidelity level trigger occurs.

11. The dynamic data fidelity level adjustment system of claim 10, wherein the FED flow control agent transmits the one or more FED messages when the FED determines whether to accept or deny the requested upstream data fidelity level.

12. The dynamic data fidelity level adjustment system of claim 11, wherein the one or more FED messages includes at least one of a success response when the FED determines to accept the requested upstream data fidelity level or a failure response when the FED determines to deny the requested upstream data fidelity level.

13. The dynamic data fidelity level adjustment system of claim 10, wherein the FED flow control agent determines whether to accept or deny the requested upstream data fidelity level based on at least one of processing power, device power, device capabilities or network conditions .

14. The dynamic data fidelity level adjustment system of claim 10, wherein the SED flow control agent transmits the one or more SED messages when the SED determines whether to accept or deny the requested downstream data fidelity level.

15. The dynamic data fidelity level adjustment system of claim 14, wherein the one or more SED messages includes at least one of a success response when the SED determines to accept the requested downstream data fidelity level or a failure response when the SED determines to deny the requested downstream data fidelity level.

16. The dynamic data fidelity level adjustment system of claim 10, wherein the SED flow control agent determines whether to accept or deny the requested downstream data fidelity level based on at least one of processing power, device power, device capabilities, or network conditions.

17. The dynamic data fidelity level adjustment system of claim 10, wherein the requested upstream data fidelity level is based on the upstream data fidelity level trigger and the requested downstream data fidelity level is based on the downstream data fidelity level trigger.

18. The dynamic data fidelity level adjustment system of claim 10, wherein the dynamic data fidelity level adjustment system is a two-way data flow system.

19. The dynamic data fidelity level adjustment system of claim 10, wherein the SED data processing agent is further configured to transmit an acknowledgement packet when the FED transmits the one or more FED messages having the success response or the failure response.

20. The dynamic data fidelity level adjustment system of claim 10, wherein the FED data processing agent is further configured to transmit an acknowledgement packet when the SED transmits the one or more SED messages having the success response or the failure response.
